(19) United States
(12) Patent Application Publication
(10) Pub. No.: US 2014/0082820 A1
(43) Pub. Date: Mar. 27, 2014

(54) INFANT BODYSUIT

(71) Applicant: STEVEN BRYAN DUNN, Beverly Hills, CA (US)

(72) Inventor: STEVEN BRYAN DUNN, Beverly Hills, CA (US)

(73) Assignee: MUNCHKIN INC., North Hills, CA (US)

(21) Appl. No.: 13/768,920

(22) Filed: Feb. 15, 2013

Related U.S. Application Data
(63) Continuation-in-part of application No. 13/625,769, filed on Sep. 24, 2012.

(51) Int. Cl. A41D 11/00; G09F 3/00

(52) U.S. Cl. CPC A41D 11/00; G09F 3/00
USPC 2/80

(57) ABSTRACT

A one-piece bodysuit for an infant having a first and second panel. At least one of the first or second panels is a multi-ply panel. At least one fastener is provided to attach the first panel to the second panel. The first panel is attached at peripheral edges to the second panel to define an opening into which an infant torso is received. The first and second panels have a fabric weight thickness and thermal property that may be the same or different.

### CROSS REFERENCE TO RELATED APPLICATIONS

This application is a continuation-in-part and claims priority to U.S. Non-Provisional application Ser. No. 13/625,769 filed Sep. 24, 2012; the contents of all of which are hereby incorporated by reference herein in their entirety into this disclosure.

### TECHNICAL FIELD

The subject disclosure relates generally to a one-piece infant bodysuit, and more specifically to a thermal insulated infant bodysuit having at least one multi-ply panel.

### BACKGROUND

In newborns and infants, the hypothalamus, and its heat regulation mechanism, is underdeveloped. Consequently, an infant's sweat glands are smaller and blood flow to the outer skin of the child is less efficient. As a result, young infants have a more difficult time acclimating in various environments.

A number of different infant garments are conventionally used by caregivers in an attempt to moderate the temperature of an infant. One common type of clothing worn by infant children (generally from a newborn age to 24 months) is known as an infant bodysuit. As is well known, the infant bodysuit typically covers the torso of the infant with a single article of clothing. Various fasteners are typically used to conveniently allow a caregiver access the infants' crotch area in order to care for and change a soiled infant diaper.

Conventionally, in order to moderate the temperature of an infant, a caregiver would lay a separate blanket or sheet over the infant. However, modernly, various dangers are associated with using a loose blanket or sheet over an infant in their bed, such as suffocation and/or overheating leading to Sudden Infant Death Syndrome (SIDS) and other deadly hazards.

Various professional organizations (such as the National Institute of Child Health and Human Development, Maternal and Child Health Bureau/HRSA, American Academy of Pediatrics, First Candle/SIDS Alliance, Association of SIDS and Infant Mortality Programs, U.S. Department of Health and Human Services, Public Health Service and the National Institutes of Health) recommend that an infant should never be placed to sleep on soft surfaces. They all agree that it is important not to use pillows, blankets, sheet, quilts, sheepskins, and pillow-like crib bumpers in the baby's sleep area, and to keep these types of soft items away from the baby's face. Thus, there is a need to efficiently moderate an infant's temperature in a safe and convenient manner without the addition of a blanket or covering.

### BRIEF DESCRIPTION OF THE DRAWINGS

Various exemplary embodiments of this disclosure will be described in detail, wherein like reference numerals refer to identical or similar components or steps, with reference to the following figures, wherein:

FIG. 1 illustrates an exemplary infant bodysuit according to the subject disclosure.

FIG. 2 shows a cross section view of the infant bodysuit.

FIG. 3 depicts an infant bodysuit with leg and arm portions according to the subject disclosure.

FIG. 4 illustrates a rear view of the infant bodysuit with leg and arm portions.

FIG. 5 depicts an infant bodysuit having leg, arm and foot covering portions according to the subject disclosure.

FIG. 6 shows a rear view of the infant bodysuit having leg, arm and foot covering portions.

FIG. 7 illustrates a cross section view of the infant bodysuit having leg, arm and foot covering portions.

FIG. 8 shows an infant lying on their back in a crib wearing the infant bodysuit.

FIG. 9 depicts an infant wearing the infant bodysuit and sitting against their back in an infant carrier.

FIG. 10 shows an infant wearing the infant bodysuit and sitting against their back in a stroller.

FIGS. 11-13 illustrate a system and method for rating the infant bodysuit.

FIGS. 14-16 depict various exemplary fastener systems for the infant bodysuit.

FIG. 17 illustrates another exemplary infant bodysuit according to the subject disclosure.

FIG. 18 shows a cross section view of the infant bodysuit in FIGS. 2 and 17.

FIG. 19 depicts a cross section view of the infant bodysuit having leg, arm and foot covering portions as shown in FIG. 5.

FIG. 20 illustrates another exemplary cross section view of the multi-ply infant bodysuit.

FIG. 21 shows yet another cross section view of the multi-ply infant bodysuit.

FIGS. 22-26 show another system and method for rating the infant bodysuit.

### DETAILED DESCRIPTION

Particular embodiments of the present invention will now be described in greater detail with reference to the figures.

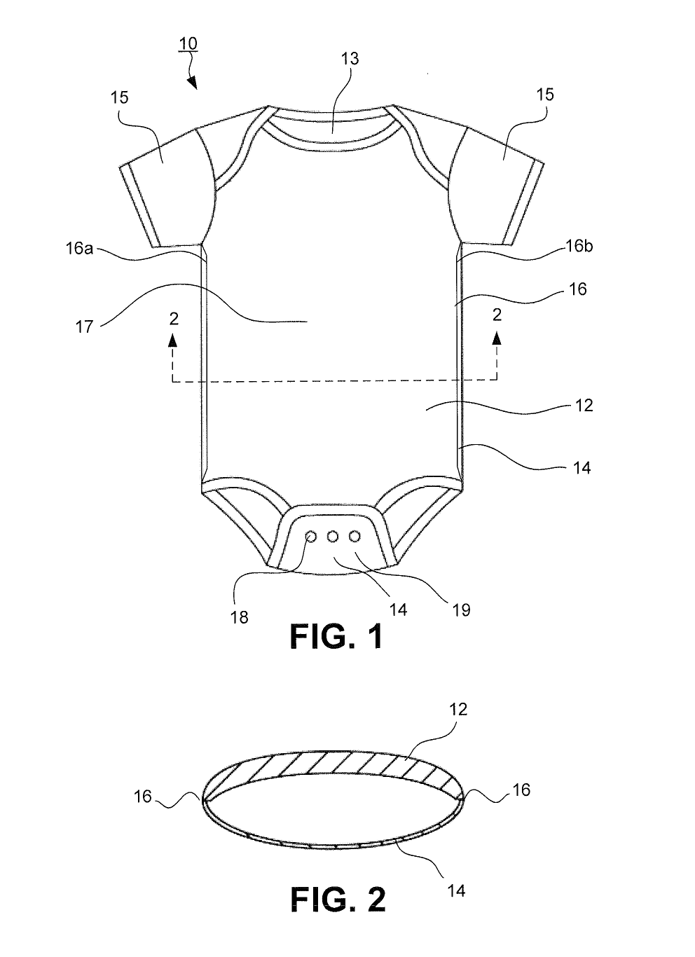

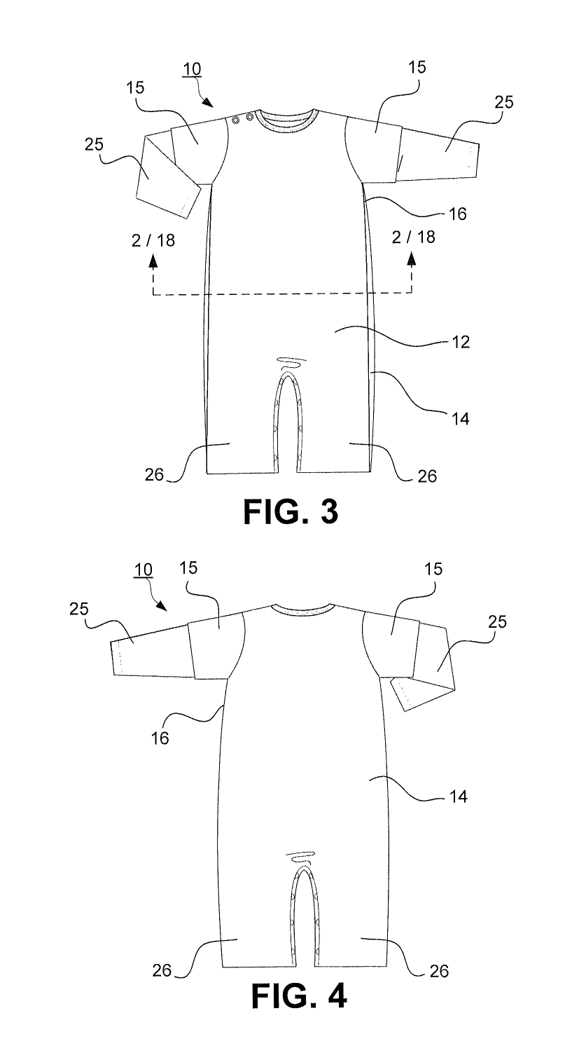

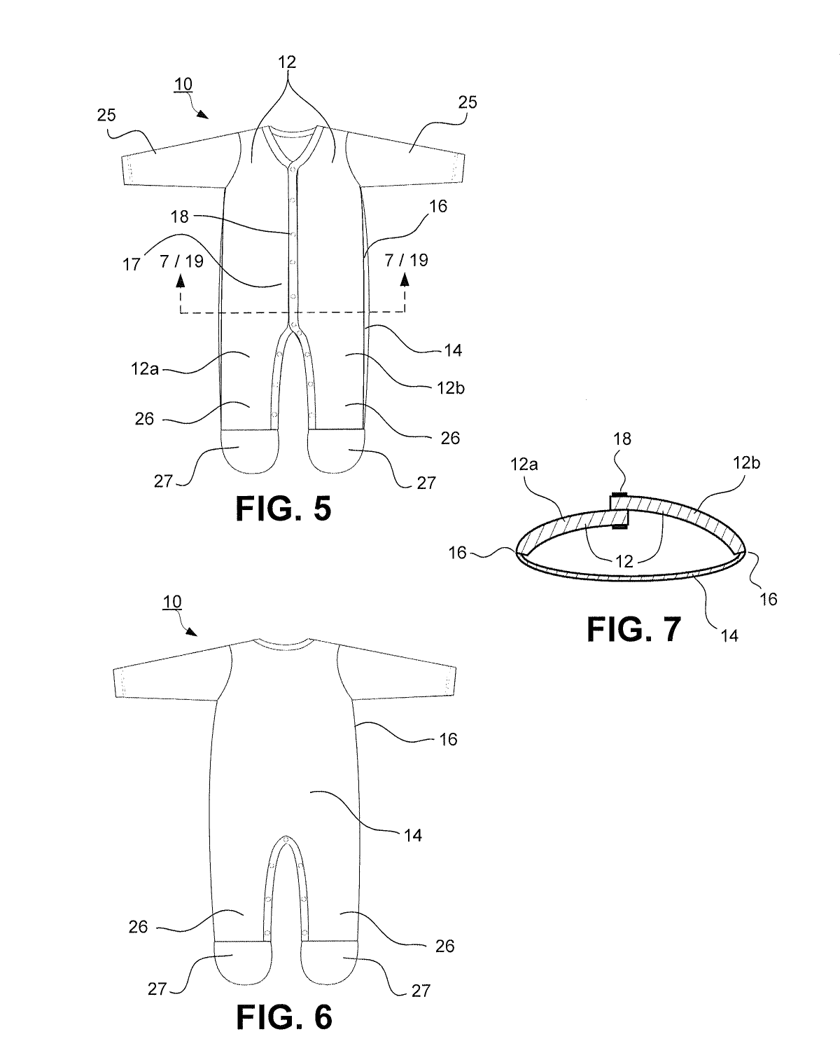

FIGS. 1 and 3-6 illustrate various exemplary infant bodysuits 10. This subject disclosure applies to various infant bodysuits, such as those that do not have sleeves, those with short sleeves 15 or no legs (such as shown in FIG. 1), those with arm 25 and leg 26 portions (as shown in FIGS. 3-6), those with foot coverings 27 (as shown in FIGS. 5-6), or any combination thereof and/or other suitable infant bodysuits.

Referring back to FIG. 1 and FIG. 2, which is a cross section view of FIG. 1. As shown, the infant bodysuit 10 is comprised of a multi-panel construction of varying thickness. The multi-panel construction is adapted to provide enhanced thermal properties similar to the effect of placing a blanket or sheet over an infant. The advantage of the infant bodysuit 10 of this disclosure is that the dangers associated with actually placing a hazardous loose blanket or sheet over the infant 20 are eliminated since a loose blanket, sheet or covering is not provided on, or around the infant 20 according to this subject disclosure. However, the effect of adding an additional blanket or covering is achieved by increasing the thickness of at least one of the panels of the infant bodysuit 10 according to this subject matter.

Conventionally, similar infant bodysuits are non-existent. That is, traditionally, a caregiver would have to lay a separate blanket or sheet over the infant in an attempt to keep the infant warm. However, various dangers have been scientifically proven with placing a loose blanket over a young infant or other soft object in a crib with the infant, such as suffocation, SIDS and/or other deadly hazards.

Various factors compound the problem, such as in the instance where a home includes a single thermostat to regulate the temperature of the entire house. For example, at night, the caregiver may desire a cooler setting so that they can rest warmly under covers while they sleep. Unfortunately, an infant also in the house will not be able to stay comfortably warm at night since using a blanket or other soft item over them in the bed would be ultra-hazardous. Other factors exacerbate the problem, such as where the temperature falls during the evening or a window is left open to allow in air. Consequently, it was previously quite difficult to moderate an infant's temperature in a safe and controlled manner.

As shown in FIG. 1, the infant bodysuit 10 includes a front first panel 12 and a rear second panel 14 of varying thickness and thermal properties. The infant bodysuit 10 further includes a neck opening 13, a pair of sleeves 15, a trunk portion 17, and a bottom portion 19. The infant bodysuit 10 is a one-piece construction in which the various panels 12, 14 and other parts of the bodysuit 10 are constructed integral as a single piece garment. It is to be understood that the bodysuit 10 may be made as a number of component parts and as a multiple-piece garment.

A row of fasteners 18 may be disposed along the rear second panel 14 adapted to be attached to a pair of mating fastener portions provided at the bottom portion of the front first panel 12. Likewise, as shown in the infant bodysuit 10 in FIG. 5, various fasteners 18 may be provided along a front portion of the trunk portion 17 of the front first panel 12 and along the inner leg portions of the infant bodysuit 10 and/or any other suitable location on the infant bodysuit 10.

Referring to FIGS. 1, 3 and 5, the front first panel 12 is attached to the rear second panel 14 at side seams 16. The first panel 12 covers a front torso portion of the infant bodysuit 10. The side seams 16 define peripheral edges that extend from an upper torso of the infant bodysuit 10 to a lower portion of the torso. In FIGS. 3-6, the side seams 16 extend from an upper torso of the infant bodysuit 10 to a lower portion, adjacent to the feet of the infant bodysuit 10.

The first panel 12 is attached at peripheral edges of the side seams 16. The side seams may be further defined as side seams 16a, 16b to illustrate the position of the side seams 16a, 16b relative to the first panel 12 and the second panel 14. The side seams 16a, 16b define the peripheral edges that bound the first panel 12 and the second panel 14. As shown, the peripheral edges of the side seams 16a, 16b extend from an upper torso of the infant bodysuit 100 to a lower portion of the torso. Likewise in various other embodiments such as shown in FIGS. 3-6, the side seams 16a, 16b may extend from an upper torso of the infant bodysuit 100 to a lower portion, adjacent to the feet of the infant bodysuit 10, 100.

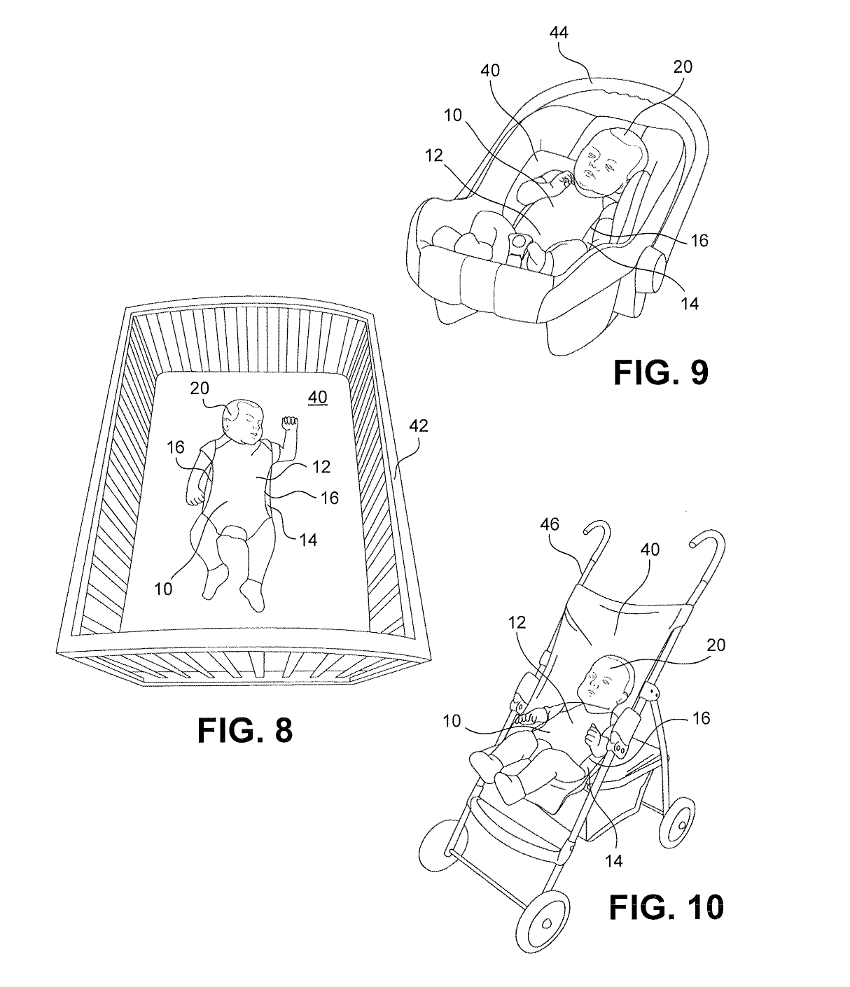

As shown in FIGS. 2 and 7, the front first panel 12 is constructed substantially thicker than the rear second panel 14. The front first panel 12 is thicker than the rear second panel 14 in order to keep the upper outermost portion of an infant 20 warm when the infant 20 is positioned with their back side adjacent to a surface as shown in FIGS. 8-10. The differentiation in the thickness between the first panel 12 and the second panel 14 is associated with various thermal insulating properties as will be discussed later in more detail.

Although the first panel 12 and the second panel 14 are shown as single-piece panels, it is to be understood that the infant body suit 10 may be constructed in a variety of different ways as multi-piece garments. For example, FIGS. 5 and 7 show the first panel 12 composed of a first panel portion 12a and a second panel portion 12b joined together by various fasteners 18. As to the front first panel 12, the first front panel portion 12a and the second front panel portion 12b extend from the side seams 16 inward to a central region over the front of the torso. In particular, the first front panel portion 12a extends from one seam to the central region defining a central peripheral edge, and the second front panel portion 12b extends from an opposite side seam 16 to the central region defining a second overlapping peripheral edge. The two central peripheral edges are disposed in an overlapping configuration and are secured together by the fastener 18. Collectively, the first front panel portion 12a and the second front panel portion 12b extends from an upper portion of the infant bodysuit 10 to a lower portion of the infant bodysuit 10 to define the first panel 12 of the infant bodysuit 10.

Likewise, it is also to be understood that the thicknesses in the front first panel 12 and the rear second panel 14 may be reversed in construction according to this disclosure. That is, the rear second panel 14 may be constructed thicker than the front first panel 12.

FIGS. 8-10 illustrate an infant 20 wearing the infant bodysuit 10 and being positioned on their backside against various surfaces 40. In FIG. 8, the infant 20 is shown lying on their back in a crib 42. In FIG. 9, the infant 20 is depicted sitting reclined with their back resting against a surface 40 in an infant carrier 44. And, in FIG. 10, the infant 20 is shown sitting upright with their back resting against a surface 40 in an infant stroller 46.

In each of these positions, heat is naturally transferred from the infant's warm body 20 outward towards the surrounding atmospheric environment that is at a lower temperature. Heat exchange from the infant 20 may take place in various ways, such as by radiation, convection, conduction or a combination of these methods.

In the various environments show in FIGS. 8-10, the infant 20 is shown wearing the bodysuit 10 and is lying with their back against the various surfaces 40. The remainder of the bodysuit 10 on the infant 20 is directly exposed to the atmospheric air. As shown, the majority of the atmospheric air surrounding the upper portion of the infant 20 is in direct contact with the first panel 12 of the infant bodysuit 10.

Heat transfer generated by the body of the infant 20 will flow from the warm infant body (i.e., a high energy and high temperature source) to a surrounding cooler object or the environment (i.e., a low energy and low temperature source). As to the lower surface 40 of the crib 42 shown in FIG. 8, the body heat of the infant's skin lying adjacent to the lower surface 40 is transferred to the surface 40 of the crib 42. The heat energy from the infant's body is radiated into the area adjacent to, and including the lower surface 40 of the crib 42. That is, the heat is transferred from the skin on the back of the infant, through the back of the infant's bodysuit 10 and into the surface 40. Since the gap between the bodysuit 10 and the surface 40 upon which the infant is lying is relatively small, the warmth generated directly from the infant 20 to the area surrounding the back of the infant's bodysuit 10 and the surface 40 collects therein and retains the heat better between the two surfaces. As a result, heat is captured and retained in that region so that the infant 20 remains warm on its back that is in contact with the surface 40 of the crib 42. The same holds true for the surfaces 40 of the infant carrier 44 and the infant stroller 46 shown adjacent to the infant's back in FIGS. 9 and 10.

Conventionally, as to the area adjacent to the front of an infant bodysuit exposed open to the atmospheric air, the heat energy radiated from the infant's body is rapidly radiated away from their body and into the atmospheric surroundings as a result of the large temperature difference between infant and the surrounding atmospheric temperature. Since there is no substantial insulator at the front of a conventional infant garment, more heat is loss via heat convection across the front side of the infant to the colder surrounding atmosphere. Consequently, an infant could not retain as much of its heat and will experience more of a cold chill from the rapid loss of heat into the colder atmospheric surroundings as well as the reciprocal receipt of cold air from the atmosphere.

Referring back to the infant bodysuit 10 according to this subject disclosure as shown in FIG. 2, at least two material panels 12, 14 of differing thickness are attached to each other at the seam 16. Various now known or later discovered methods of attachment between the first panel 12 and the second panel 14 may be used to connect the various fabrics in the infant bodysuit to each other, including but not limited to, sewing, bonding, gluing, and/or other suitable method for attaching the fabrics of the same or different thickness to each other.

The first panel 12 is substantially larger in material thickness then the second panel 14 of the infant bodysuit 10 thereby mimicking the insulation of a blanket, sheet or other soft insulating material over the infant. The differentiation in the weight of the material fabric provides the convenience of providing an all-inclusive infant bodysuit 10 capable of replicating the insulation of a blanket or sheet lying over the infant without actually and dangerously adding one to the environment in which the infant is located.

Therefore, as to the area adjacent to the first panel 12 of the infant's bodysuit 10 that is exposed open to the atmospheric air, the heat energy loss radiated from the infant's body 20 is dramatically reduced and substantially prevented from being lost from the infant's body across the infant bodysuit 10 and into the atmospheric surroundings. The thicker first panel 12 acts as an insulator to prevent the loss of heat from the infant's body. The first panel 12 thickness and the second panel 14 thicknesses can be varied depending on the temperature and atmospheric conditions that the infant is to be placed into according to this disclosure.

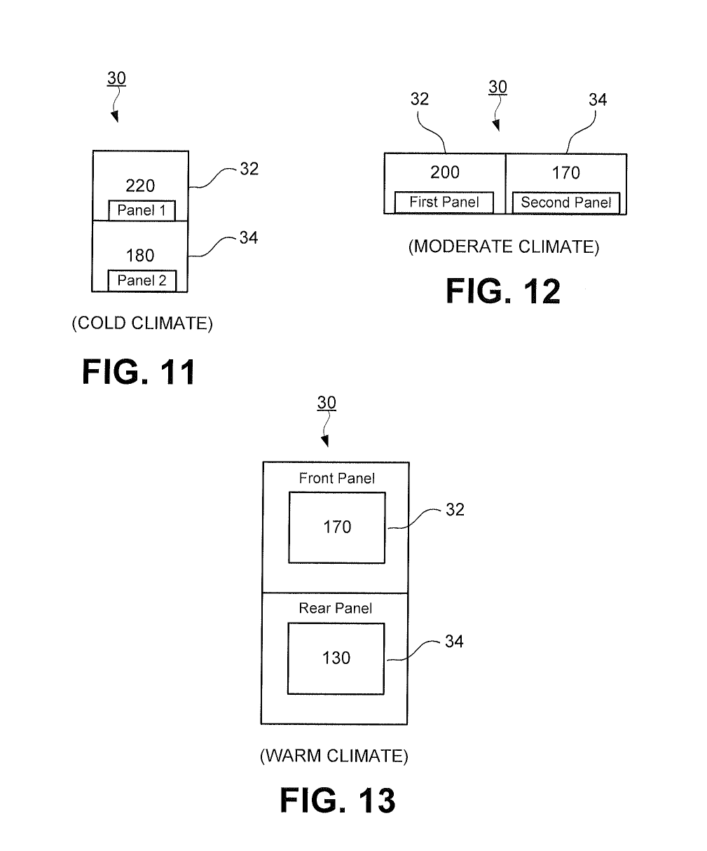

FIGS. 11-13 illustrate a rating system and method for identifying the different fabric/material weights of the multiple components of the infant bodysuit 10. The rating system may be presented as a label 30 including indicia that is based on the weight of the material fabric in grams/meter squared, or other suitable dimension. The differentiation in the weight of the material fabric provides the convenience of providing an all-inclusive infant bodysuit 10 capable of replicating the insulation of a blanket or sheet lying over the infant without the danger of actually laying a loose blanket or sheet on top of the infant thereby alleviating the danger of suffocation as well as other hazards.

The rating system can be associated with a broad range of various temperatures adapted for use and easily identifiable by a caregiver year-round. For example, as shown in FIG. 11, the label 30 may include a first indicia associated with a first rating for a cold weather climate such as an outdoor temperature of 40 degrees or the like. In that case, the label 30 may include “220” as first indicia 32 used to identify the jersey weight thickness of the first panel 12. Likewise, second indicia 34 may include “180” to identify the jersey weight thickness of the second panel 14. The unique rating system for the combined material weight for the first and second panels 12, 14 will provide a suitable thickness for the infant bodysuit when in a colder climate, such as outside in a stroller on a cold day. The infant 20 will remain comfortably warm having the heavier rated weight 32 for the material fabric of the first panel 12 to block the colder air and better insulate the infant from the colder atmospheric air.

In a second example shown in FIG. 12, the label 30 may include first indicia associated with a first rating for a moderate weather climate such as an outdoor temperature of 70 degrees or the like. In that case, the label 30 may include “200” as first indicia 32 used to identify the jersey weight thickness of the first panel 12. Likewise, the label may include “170” as second indicia 34 used to identify the jersey weight thickness of the second panel 14. The combined weight of the first and second panels 12, 14 will provide a suitable thickness for the infant bodysuit for the moderate climate. The infant 20 will remain comfortable in the moderate climate having the slightly heavier rated weight 32 for the material fabric of the first panel 12 to better insulate the infant from the moderate atmospheric air. As shown in FIG. 12, the indicia may be positioned in a variety of different shapes and positions.

In a third example shown in FIG. 13, the label 30 may include a first indicia associated with a first rating 32 for a much warmer weather climate such as an outdoor temperature of 85 degrees or the like. In that case, the label 30 may include a first indicia 32 at “170” used to identify the jersey weight thickness of the first panel 12. Likewise, the second indicia 34 may be “130” used to identify the jersey weight thickness of the second panel 14. The combined weight of the first and second panels 12, 14 will provide a suitable thickness for the infant bodysuit for the warmer climate. The infant 20 will be able to remain reasonably cool and protected with a lighter weight fabric at the first panel 12 in the much warmer climate.

As demonstrated, the differing weights and/or reference numbers in the label 30 may be associated with the weather or temperature for a particular day or the environment in which the infant will be located. Likewise, the various ranges may vary by approximately 30 to 50 grams/meter squared and/or any other preferred rating. Although described as a jersey knit fabric in this example it is to be understood that any suitable fabric may be used according to the subject disclosure.

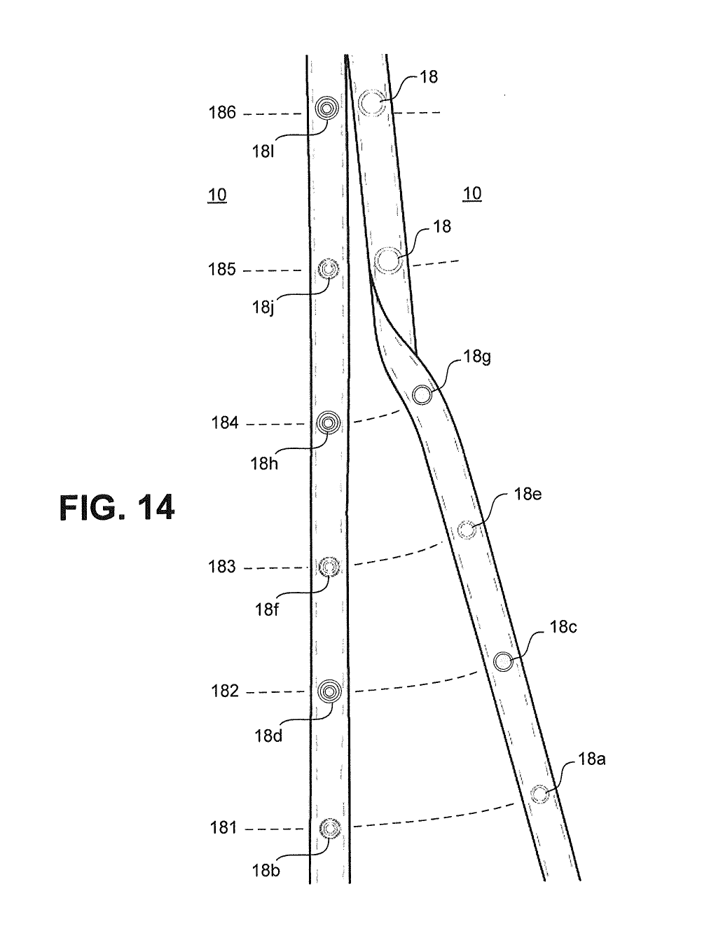

FIGS. 14-16 illustrate a further aspect of the subject disclose in which various fasteners 18 used on the infant bodysuit 10 are constructed in a variety of different sizes, shapes, materials and colors in order to assist the caregiver when securing the infant bodysuit 10 to the infant 20. For example, in FIG. 14, the various fasteners 18 depict various first snap sockets 18a, 18c, 18e, 18g, 18i (not shown), 18k (not shown), aligned with, and positioned to align with, mating receiving snap studs 18b, 18d, 18f, 18h, 18j, 18l. It is to be understood that the various fasteners 18 may be uniquely arranged and positioned anywhere on the infant bodysuit 10.

As shown, the various snap sockets 18a, 18c, 18e, 18g are paired with associated mating snap studs 18b, 18d, 18f, 18h in an alternating color scheme. For example, at the lower end of the fastener assembly, a first fastener arrangement 181 includes a snap socket 18a paired with a snap stud 18b of a similar first color. A second fastener assembly 182 located above the first fastener assembly 181 includes a snap socket 18c paired with a snap stud 18d of a second color. Proceeding upward, a third fastener assembly 183 located above the second fastener assembly 182 includes a snap socket 18e paired with an associated snap stud 18f of the first color. Proceeding upward again, a fourth fastener assembly 184 located above the third fastener assembly 183 includes a snap socket 18g paired with an associated snap stud 18h of the second color. The fifth and sixth fastener assemblies 185, 186 would follow the same alternating scheme.

As shown, the first and second fastener color scheme is provided in the infant bodysuit 10 to alternate in adjacent positions. The advantage of constructing this alternating fastener color scheme is to provide the caregiver with a visual indicator as to the proper alignment of associated pairs of snap studs and snap sockets. In this manner, the caregiver can conveniently and easily align the proper pairs of snap studs and snap sockets on the infant bodysuit 10. Although shown as an alternating color scheme, the associated pairs of snap studs and snap sockets may be distinguished by various parameters, such as size, shape material as well as color. Further, more than two color schemes may be utilized amongst the various fasteners 18 positioned adjacent to each other.

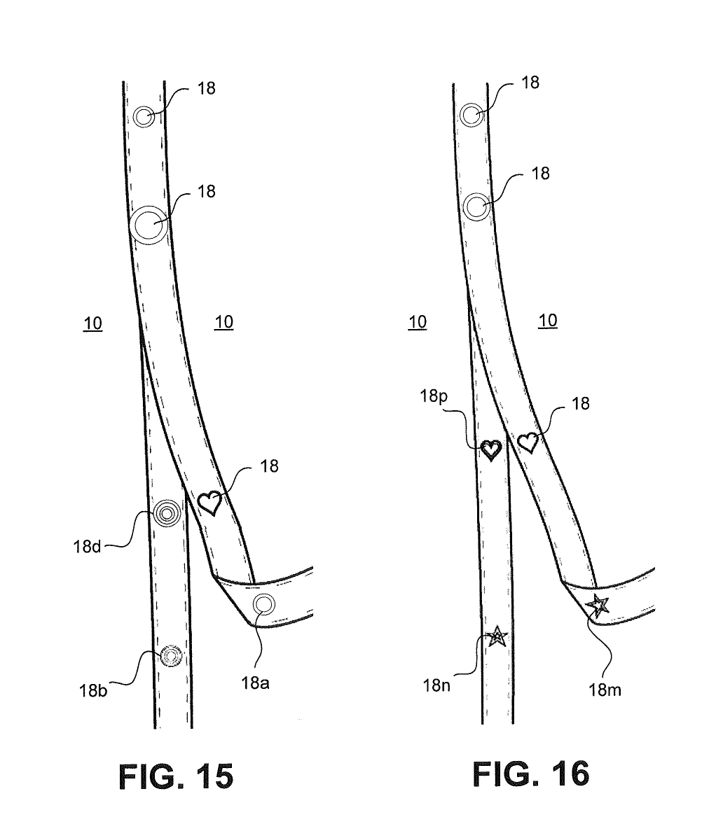

As illustrated at the top of FIG. 14, the outside of the fasteners 18 of the fastener assemblies 185 and 186 appear substantially similar when the fasteners 18 are closed. In an alternative, FIG. 15 shows an example of the outside of the fasteners 18 having a different appearance. In FIG. 15, the first uppermost fastener 18 is smaller in construction then the outside of the next lower fastener 18, which is much larger.

As shown in FIGS. 15 and 16, it is within the scope of this disclosure to vary the construction of the fasteners into an assortment of different sizes, shapes, materials and colors, such as a small circle, a large circle, a heart, a star, and/or any other shape, size or color. As mentioned previously, the snap studs and mating snap sockets can be color coordinated, such as by matching the innermost or outermost elements of the fasteners in brass, silver and/or any other preferred color as shown in FIGS. 14-15 and in accordance with this disclosure.

Likewise, the inner snap stud and snap socket can be constructed in any configuration. For example, FIG. 16 depicts the inner male snap socket 18m and female snap stud 18n taking the shape of a star. Shown above the heart is the inner male snap socket and female snap stud 18p fastener assembly taking the shape of a heart. Any suitable size or shape can be constructed according to this disclosure.

The advantage to providing different sizes, shapes and/or colors to the fasteners is to conveniently and easily allow the caregiver to secure the infant's bodysuit 10, 100 onto the infant 20. Alignment of the numerous fasteners 18 can be performed conveniently without misaligning the fasteners 18 since both visual and tactile distinctions can be easily and readily apparent to the caregiver who aligns the various fasteners 18 on the infant bodysuit 10, 100.

Traditionally, aligning the various fasteners has been quite challenging, especially when an infant is kicking and thrusting their arms and legs around as the caregiver attempts to snap fasten an infant suit onto the infant. By providing the visual and tactile distinctions of the fasteners 18 according to this subject disclosure, the caregiver can more easily align the appropriate snap studs and mating snap sockets positions.

Although snap fasteners are discussed herein, it is to be understood that various fasteners may be selected, such as but not limited to, snaps studs with associated snap sockets, pins, hook and loop fastener, and/or any other suitable fastener capable of fastening the infant bodysuit in accordance with the subject disclosure.

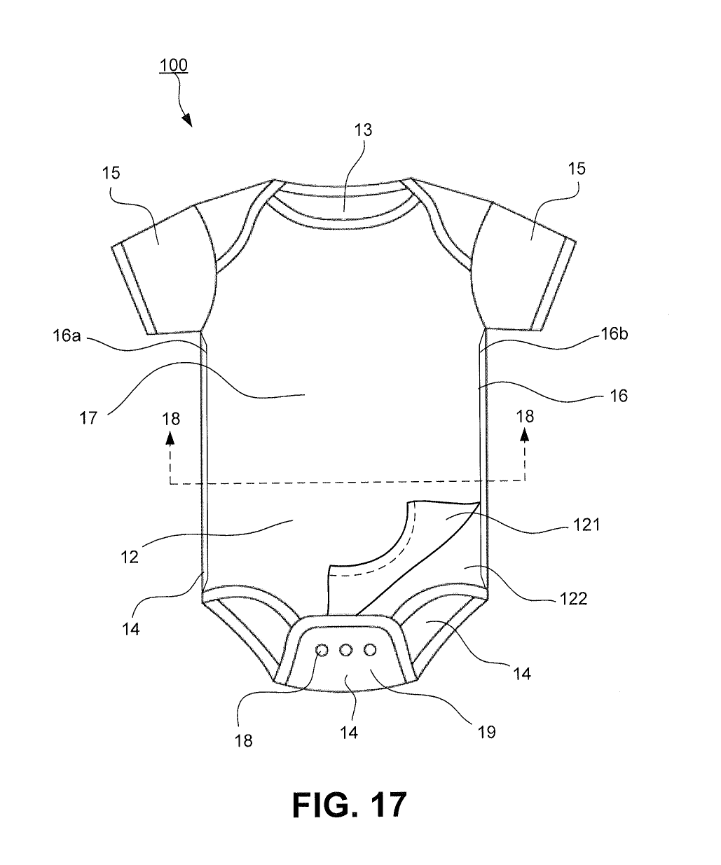

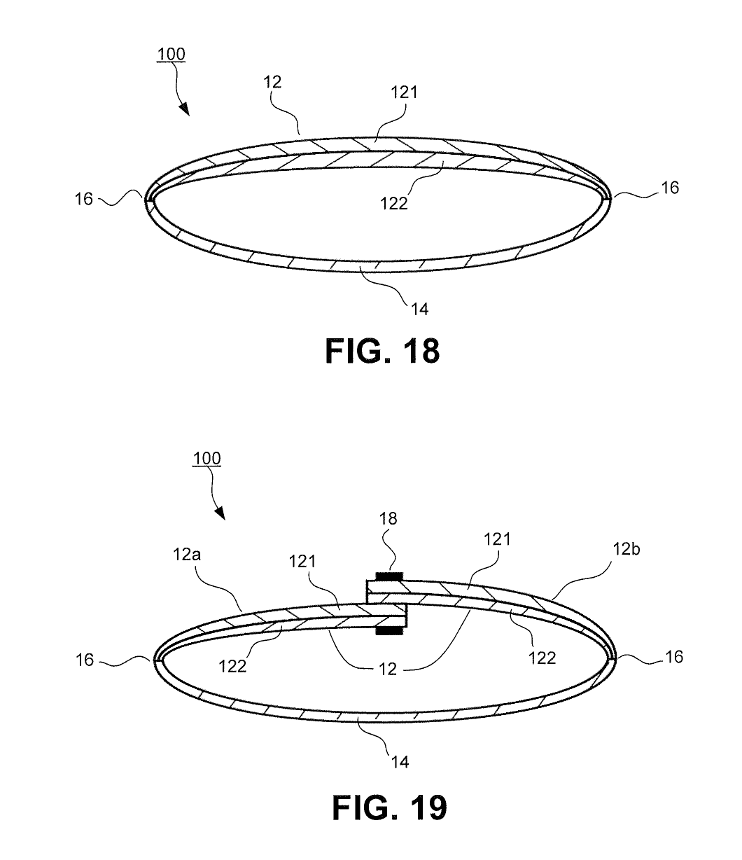

FIG. 17 and cross section view FIG. 18 illustrate another exemplary infant bodysuit 100 in which the first panel 12 is a multi-layer or multi-ply panel. The multi-ply panels of the first panel 12 is embodied as at least a pair of sub panels 121 and 122 disposed adjacent to each other.

Each of the plys or sub panels 121 and 122 are overlaid or layered and share contiguous boundary edges. The boundary edges of the sub panel 121 is similar in shape to the boundary edge of the sub panel 122 (and/or other sub panels included). That is, as shown in FIG. 17, the left and right boundary edges of both of the sub panels 121, 122 extend from a first seam 16a to a second seam 16b, respectively, across the front torso of the infant bodysuit 100. Likewise, the upper and lower boundary edges of the sub panels 121, 122 may extend from the upper portion of the infant bodysuit 100 adjacent to the neck, to the lower portion of the infant bodysuit 100 adjacent to the crotch as shown in FIG. 17, or adjacent to the feet for the infant bodysuit 10, 100 shown in FIGS. 3-6.

To illustrate the multi-ply nature of the first panel 12, FIG. 17 depicts the multi-ply panels 121, 122 being partially separated. A first sub panel 121 is shown partially separated from the sub panel 122 as it is depicted flipped upward away from the second sub panel 122.

In more detail, FIG. 17 shows the first panel 12 of the infant bodysuit 100 including a first sub panel 121 and a second sub panel 122. The combined first panel 12 may be constructed thicker than the rear second panel 14.

This exemplary infant bodysuit 100 construction is applicable to all of the various embodiments and features described above. It is also to be understood that the combined multi-ply panel having the greater number of panels may be thinner than the other panel in the infant bodysuit 100 according to this subject disclosure.

As before, the infant bodysuit 100 further includes a neck opening 13, a pair of sleeves 15, a trunk portion 17, bottom portion 19 and various fasteners 18. The infant bodysuit 100 is a one-piece construction in which the various panels 121, 122, 14 and other parts of the bodysuit 100 are constructed integral as a single piece garment. It is to be understood that the bodysuit 100 may be made as a number of component parts and as a multiple-piece garment.

Referring to FIGS. 17, 18 and 19, the various sub panels 121, 122 of the combined multi-ply first panel 12 are attached to the second panel 14 at side seams 16a, 16b as was similarly constructed with respect to FIGS. 1-7. As before, the side seams 16 may be further defined as side seams 16a, 16b to illustrate the position of the side seams 16a, 16b relative to the first panel 12 and the second panel 14. Arranged and fastened at the side seams 16a, 16b adjacent to each other, the sub panels 121, 122 combined as the first panel 12 will feel much like a single panel that is constructed thicker than the second panel 14. The combined multi-ply first panel 12 covers a front torso portion of the infant bodysuit 100. The multi-ply panels 121, 122 of the first panel 12 are attached at their peripheral edges of the side seams 16a, 16b. The side seams 16a, 16b define the peripheral edges that bound the various sub panels 121, 122 (or more sub panels if included) of the multi-ply first panel 12. As shown, the peripheral edges of the side seams 16a, 16b extend from an upper torso of the infant bodysuit 100 to a lower portion of the torso. Likewise in various other embodiments such as shown in FIGS. 3-6, the side seams 16a, 16b may extend from an upper torso of the infant bodysuit 100 to a lower portion, adjacent to the feet of the infant bodysuit 10, 100.

Combining the front first sub panel 121 with the front second sub panel 122 causes the first panel 12 to be constructed thicker than the rear second panel 14 in overall material thickness. The first panel 12 is thicker than the rear second panel 14 in order to keep the upper outermost portion of an infant 20 warm when the infant 20 is positioned with their back side adjacent to a surface as shown in FIGS. 8-10. The difference in the thickness between the first panel 12 and the second panel 14 is related with various thermal insulating properties as discussed herein.

The first panel 12 is substantially thicker in combined material thickness then the second panel 14 of the infant bodysuit 100. The added thickness in front of the infant bodysuit 100 mimics the insulation of adding a blanket, sheet or other soft insulating material over the infant without the danger of adding a loose item to the environment in which the infant is situated. The enhanced thickness of the first panel 12 allows the convenience of providing an all-inclusive infant bodysuit 100 capable of replicating the insulation of a blanket or sheet lying over the infant without physically adding one. As mentioned previously, the thicker first panel 12 acts as an insulator to prevent the loss of heat outward into the surrounding environment from the infants' body.

As before, it is understood that the multi-ply paneling and/or thicknesses in the first panel 12 and the second panel 14 of the infant bodysuit 100 may be reversed in construction according to this disclosure. That is, the second panel 14 may be constructed thicker with more multi-plys than the first panel 12 according to this subject disclosure. Likewise, the weight and/or thickness of the first front sub panel 121 and the second front sub panel 122 may also be varied differently according to various climate schemes to account for the various weather conditions in the infant's surrounding environment as will be described in more detail below.

FIG. 19 relates, for example, to the garments shown in FIGS. 5 and 6 and further depicts the front first panel 12 composed of a first front panel portion 12a and a second front panel portion 12b joined together by various fasteners 18. The first front panel portion 12a is constructed from a first front sub panel 121 and a second front sub panel 122. Likewise, the second front panel portion 12b is also constructed from a first front sub panel 121 and a second front sub panel 122.

The first front panel portion 12a and the second front panel portion 12b of the front first panel 12 extend from opposite side seams 16 inward to a central region over the front of the torso of the infant. In particular, the first front panel portion 12a extends from one seam to the central region defining a central peripheral edge, and the second front panel portion 12b extends from an opposite side seam 16 to the central region defining a second overlapping peripheral edge. The two central peripheral edges are disposed in an overlapping configuration and are secured together by the fastener 18. Collectively, the first front panel portion 12a and the second front panel portion 12b extends from an upper portion of the infant bodysuit 100 to a lower portion of the infant bodysuit 100 and define the first panel 12 of the infant bodysuit 100.

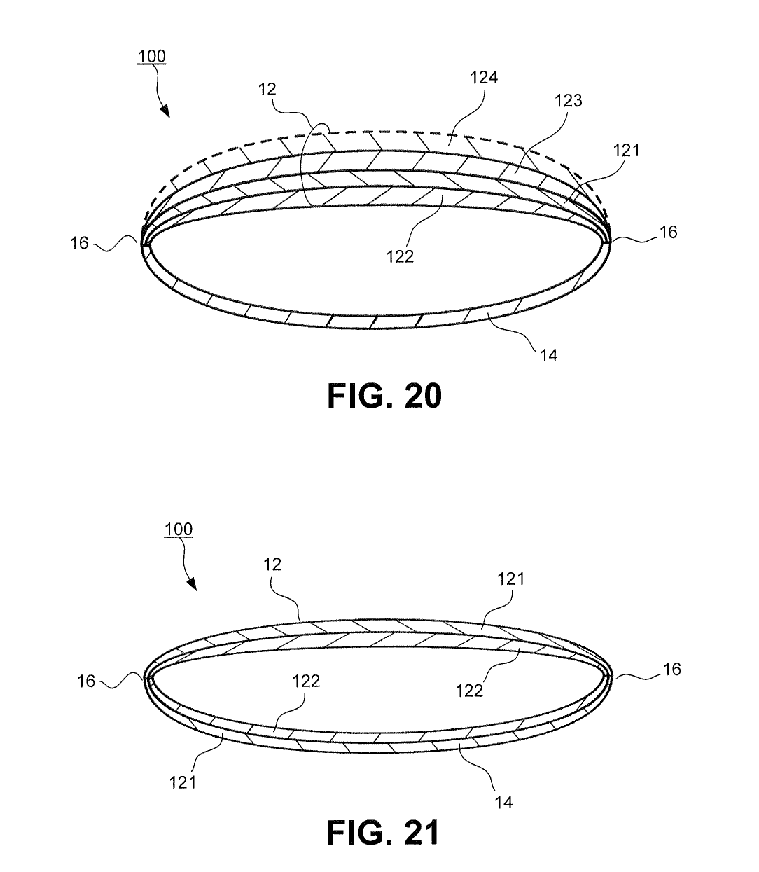

FIGS. 20-21 depict exemplary cross sections of the one-piece or unitary construction infant bodysuit 100. It is to be understood that the first panel 12, or the second panel 14 in any of the embodiments disclosed herein can be constructed of any number of multiple plys of material.

For example, in FIG. 20, the first panel 12 is constructed as a multi-ply panel composed of a number of sub panels 121, 122, 123, 124 (shown in hidden line) disposed adjacent to each other. In particular, the combined first panel 12 of the infant bodysuit 100 includes a front first sub panel 121, front second sub panel 122, front third sub panel 123, and shown in hidden line can include a front forth sub panel 122 or more according to this subject disclosure. As shown in FIG. 20, due to the multi-ply first panel 12, the combined multi-ply first panel 12 is thicker than the second panel 14.

FIG. 21 shows the second panel 14 including various sub panels 121, 122 as well the first panel 12. It is to be understood that the sub panel construction for the infant bodysuit 100 is applicable to either panel 12, 14. The various sub panels of the first panel 12 and the second panel 14 are positioned in a contiguous layered fashion on top of each other. The various sub panels of the first panel 12 and the second panel 14 extend from a first side seam 16 on one side of the infant bodysuit 100 to a second side seam 16 disposed on an opposite side of the infant bodysuit 100. The various sub panels of the first panel 12 and the second panel 14 also extend from an upper portion of the infant bodysuit 100 to a lower portion of the infant bodysuit 100 to cover the torso of an infant.

The exemplary infant bodysuit 100 constructions are applicable to all of the various embodiments and features described above. These infant bodysuits 100 are a one-piece construction in which the various panels 12, 14 and their respective sub panels and other parts of the bodysuit 100 are constructed integral as a single piece garment. It is to be understood that the bodysuit 100 may be made as a number of component parts and as a multiple-piece garment. As before, the various sub panels 121, 122, 123, 124 of the combined first panel 12 and/or various sub panels of the second panel 14 are attached at side seams 16. The various sub panels are arranged in layers having contiguous peripheral edges and are fastened adjacent to each other such that the various sub panels feel like a single panel.

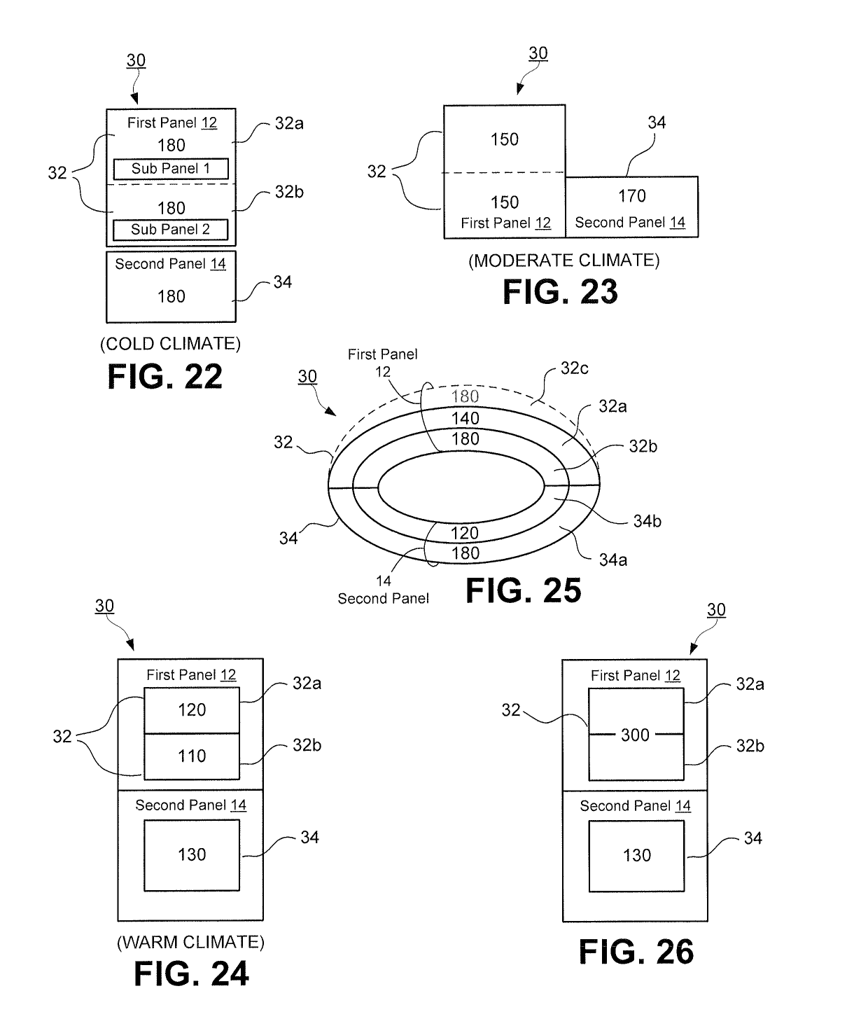

FIGS. 22-26 illustrate another rating system and method for identifying the different fabric/material weights of the multiple components of the infant bodysuit 100. As before, the rating system may be presented as a garment label 30 of varying sizes and/or shapes including indicia that identifies the weight of the material fabric in grams/meter squared, or other suitable dimension to identify the difference between the first panel 12 and the second panel 14.

The difference in the thickness and/or material weight of the fabric provides the convenience of an all-inclusive infant bodysuit 100 that is capable of replicating the insulation of a blanket or sheet lying over the infant. However, the danger of actually laying a loose blanket or sheet on top of the infant is eliminated thereby alleviating the danger of suffocation as well as other potentially lethal hazards.

The various ratings selected for the label 30 may be associated with a broad range of environmental temperature conditions. The rating on the label 30 can be provided on the infant bodysuit 100 to allow a caregiver to conveniently determine a suitable infant bodysuit to be worn in response to the temperature condition on a particular day.

For example, in FIG. 22, the garment label 30 may include indicia associated with a rating for a cold weather climate such as one in which an outdoor temperature of 40 degrees or the like exists. In that case, the label 30 may include “180” as indicia 32a used to identify a jersey weight thickness for a front first sub panel 121, and “180” as indicia 32b to identify a weight for the front second sub panel 122.

It is to be understood that instead of separately identifying the weight of the front first sub panel 121 (Subpanel 1 in FIG. 22) and the weight of the front second sub panel 122 (Subpanel 2 in FIG. 22), a combined weight thickness may be assigned by indicia 32 representing an overall combined thickness of both the front first sub panel 121 and the front second sub panel 122, collectively referred to as the first panel 12 (such as shown in the rating system of FIGS. 11-13). Likewise, a combined weight thickness rating may be assigned for indicia 32 for two or more sub panels such as for multi-ply panel 12 shown in FIG. 20, and multi-ply panels 12 and 14 shown in FIG. 21. The combined weight thickness rating assigned for indicia 32 may be represented for any one of the various labels 30 having at least two sub panels shown in FIGS. 22-26.

As before and shown in FIGS. 11 and 22, a second indicia 34 may be used to identify the jersey weight thickness of the second panel 14 and may include “180”. The unique rating system for the combined material weight for the first and second panels 12, 14 will provide a suitable thickness for the infant bodysuit 100 when in a colder climate, such as outside in a stroller on a cold day. The infant 20 will remain comfortably warm having the heavier rated weight 32 for the material fabric of the first panel 12 to block the colder air and better insulate the infant from the colder atmospheric air.

In a second example shown in FIG. 23, the label 30 may include indicia associated with a first rating for a moderate weather climate such as an outdoor temperature of 70 degrees or the like. In that case, the label 30 may include “150” (or some other number used to identify the combined thickness of the first and second sub panels 121, 122) as a first indicia 32 used to identify the jersey weight thickness of the first and second front sub panels 121, 122 for the first panel 12. Likewise, the label may include “170” as a second indicia 34 used to identify the jersey weight thickness of the second panel 14. The combined weight of the first panel 12 and the second panel 14 will provide a suitable thickness for the infant bodysuit 100 for the moderate climate. The infant 20 will remain comfortable in the moderate climate having the slightly heavier rated combined weight 32 for the material fabric of the first panel 12 to better insulate the infant from the moderate atmospheric air. As further shown in FIGS. 22-26, the label and identifying indicia may be positioned in a variety of different shapes and positions.

In a third example shown in FIG. 24, the garment label 30 may include “120” as indicia 32a used to identify a jersey weight thickness for a front first sub panel 121, and “110” as indicia 32b to identify a weight for the front second sub panel 122. As shown, the front first sub panel 121 and the front second sub panel 122 can be constructed as different weight thicknesses in an infant bodysuit 100.

This infant bodysuit 100 may be constructed for a much warmer weather climate such as an outdoor temperature of 85 degrees or the like. The second indicia 34 may be “130” used to identify the jersey weight thickness of the second panel 14. The weight of the combined first panel 12 and the second panel 14 will provide a suitable thickness for the infant bodysuit for the warmer climate. The infant 20 will be able to remain reasonably cool and protected with a lighter weight fabric at the first panel 12 in the much warmer climate.

FIG. 25 depicts a curved shape example for a garment label 30 of a multi-ply infant bodysuit 100. As shown, both the first panel 12 and the second panel 14 include at least two sub panels of varying weight thickness. In particular, the first panel 12 is comprised of more than two sub panels 32a, 32b, 32c. Sub panel 32a is designated “140”, sub panel 32b is designated “180” and sub panel 32c is designated “180.” Any number of sub panels may be included in the first panel 12 or the second panel 14. An overall designation may be assigned a single indicia 32 to identify an overall jersey weight thickness for the first panel 12.

The second panel 14 is comprised of at least two sub panels 34a, 34b. Sub panel 34a is designated “180” and sub panel 34b is designated “120.” An overall designation may be assigned a single indicia 34 to identify an overall jersey weight thickness for the second panel 14.

The weight of the multi-ply first panel 12 and the multi-ply second panel 14 will provide a suitable thickness for the infant bodysuit in a particular climate. As such, the infant 20 will be able to remain reasonably comfortable and protected in the surrounding environment.

FIG. 26 illustrates an example for a garment label 30 of a multi-ply infant bodysuit 100. As shown, the first panel 12 includes at least two sub panels 32a, 32b. In this embodiment, a combined designation “300” is provided for indicia 32. As before, any number of sub panels may be included in the first panel 12 or the second panel 14 and a single combined designation may be provided by a single indicia 32 representing the combined multi-ply paneling.

As demonstrated, the differing weights and/or reference numbers in the label 30 may be associated with the weather or temperature for a particular day or the environment in which the infant will be located. Likewise, the various ranges may vary by any preferred range and/or any other preferred rating for a variety of different environments. Although described as a jersey knit fabric in this example it is to be understood that any suitable fabric may be used according to the subject disclosure. Each of the features described herein increases the comfort of the infant by providing warmth, visual indicia identifying the material weight and thickness of the infant bodysuit 10, 100 and easy and convenience to the caregiver placing the infant bodysuit 10, 100 onto the infant 20. These various features improve the appearance of the infant bodysuit 10, 100. It is believed that each of the features of the bodysuit 10, 100 also increase the ease of use of the bodysuit 10, 100 to the caregiver, by providing easily identifiable fasteners that are tactile and visually convenient to align and fasten together.

While various features of the present design have been discussed separately, it should be understood that any of these features may be combined in a body suit 10, 100 with or without any other of the features or combination of the features. The infant bodysuit design described herein is applicable to any different type of infant bodysuit. Thus, it may be applicable to bodysuits having different types of neck openings, sleeves, and composed of any material suitable for a bodysuit, and could be equally applicable to other possible variations of bodysuits.

Although discussed with respect to an infant bodysuit, it is to be understood that the multi-ply paneling of this subject disclosure may be adapted for use with any type of suitable garment. The garment may be for a person of any age range in which the thermal insulation property of the particular garment is to be taken into consideration based on the environmental weather condition and climate into which the wearer of the garment will be subjected.

Various material and fabrics may be used in accordance with the subject disclosure. For example, various natural and/or man-made fabrics may be employed, such as knits and woven fabrics selected from at least one of a light weight, medium weight, and/or heavy weight fabric and/or other suitable material fabric. The infant bodysuit 10, 100 can also be made from a light, stretchable material, such as elasticized cotton, muslin, fleece, blended materials and/or other suitable material. Other materials may include the use of organic and/or unbleached materials which are suitable for infant care.

The first panel 12 may be constructed to be a thicker weave construction than the second panel 14 of the infant bodysuit 10. The finished material is preferably an ultra soft fabric so that when placed against a baby's skin, the material is extremely soft and soothing to the infant. In order to obtain a soft fabric construction, various softening processes may be applied to the fabric, such as for example, using silicon to soften the fabric, washing the material, mechanically brushing the fabric to soften the material fabric and/or any other suitable type of softening process in accordance with the subject disclosure.

The illustrations and examples provided herein are for explanatory purposes and are not intended to limit the scope of the appended claims. It is to be understood that the “first panel” and “second panel” is may be interchanged. It will be recognized by those skilled in the art that changes or modifications may be made to the above described embodiment without departing from the broad inventive concepts of the invention. It is understood therefore that the invention is not limited to the particular embodiment which is described, but is intended to cover all modifications and changes within the scope and spirit of the invention.

What is claimed:

1. A one-piece infant bodysuit comprising:
a first panel having a first material weight thickness; and
a second panel having a second material weight thickness,
wherein the first panel is a multi-ply material, the multi-ply material of the first panel is attached at peripheral edges to the second panel to define an opening into which an infant torso is received.

2. The one-piece infant bodysuit recited in claim 1, wherein the second panel has a second material weight thickness different from the first panel.

3. The one-piece infant bodysuit recited in claim 1, wherein the first panel covers a front torso portion of the infant body suit, and the second panel covers a rear torso portion of the infant body suit, and wherein the peripheral edges define seams extending from an upper torso to a lower portion of the infant bodysuit.

4. The one-piece infant bodysuit recited in claim 1, further comprising a label comprising a first indicia associated with the two-ply material of the first panel, and a second indicia associated with the second panel.

5. The one-piece infant bodysuit recited in claim 4, wherein the first indicia defines a first thermal property associated with the first material weight thickness of the first panel, and the second indicia defines a second thermal property associated with the second material weight thickness of the second panel.

6. The one-piece infant bodysuit recited in claim 1, wherein the multi-ply material of the first panel is comprised of at least:
a first sub panel of a first material weight; and
a second sub panel of the first material weight or a second material weight.

7. An infant bodysuit comprising:
a first panel having a first material weight associated with a first thermal property; and
a second panel having a second material weight associated with a second thermal property different from the first panel, and
wherein the first panel is attached at peripheral edges to the second panel to define an opening into which an infant torso is received.

8. The infant bodysuit recited in claim 7, wherein at least one of the first panel or the second panel is a multi-ply material.

9. The infant bodysuit recited in claim 8, wherein the multi-ply material is comprised of at least:
a first sub panel of a first material weight; and
a second sub panel of the first material weight or a second material weight.

10. The infant bodysuit recited in claim 9, further comprising a label having a first indicia associated with a combined material weight of the multi-ply material representing the combined weight of the first sub panel and second sub panel.

11. The infant bodysuit recited in claim 7, wherein the first panel covers a front torso portion of the infant body suit, and the second panel covers a rear torso portion of the infant body suit, and wherein the peripheral edges define seams extending from an upper torso to a lower portion of the infant bodysuit.

12. The infant bodysuit recited in claim 7, further comprising a label having a first indicia associated with the first material weight of the first panel and a second indicia associated with the second material weight of the second panel.

13. An infant bodysuit comprising:
a front multi-ply panel, each ply sharing contiguous boundaries;
a rear panel attached at seams to the front multi-ply panel defining an opening into which an infant torso is received; and
a label having a first indicia.

14. The infant bodysuit recited in claim 13, wherein the front multi-ply panel comprises at least:
a first sub panel of a first material weight; and
a second sub panel of the first material weight or a second material weight.

15. The infant bodysuit recited in claim 13, wherein:
the first indicia is associated with an overall material weight of the front multi-ply panel; and
a second indicia associated with a third material weight of the rear panel different from the front multi-ply panel.

16. The infant bodysuit recited in claim 13, wherein the front multi-ply panel covers a front torso portion of the infant body suit, and the rear panel covers a rear torso portion of the infant body suit, and wherein the seams extend from an upper torso to a lower portion of the infant bodysuit.

17. A one-piece infant bodysuit comprising:
a first panel; and
a second panel, the first panel is attached at peripheral edges to the second panel to define an opening into which an infant torso is received, and
wherein at least one of the first panel or the second panel is a multi-ply material, each of the plys sharing contiguous boundaries.

18. The one-piece infant bodysuit recited in claim 17, wherein the plys in the multi-ply material are comprised of at least:
a first sub panel of a first material weight; and
a second sub panel of the first material weight or a second material weight.

19. The one-piece infant bodysuit recited in claim 17, wherein:
the first panel covers a front torso portion of the infant body suit; and
the second panel covers a rear torso portion of the infant body, and
wherein the seams extend from an upper torso to a lower portion of the infant bodysuit.

20. The one-piece infant bodysuit recited in claim 17, further comprising:
a label comprising:
a first indicia is associated with an overall material weight of the multi-ply material; and
a second indicia associated with another material weight of the second panel.
